(19) United States
(12) Patent Application Publication
(10) Pub. No.: US 2011/0090891 A1
(43) Pub. Date: Apr. 21, 2011

(54) MICROWAVE RADIO COMMUNICATIONS DEVICE AND RELATED METHOD OF OPERATION AND NETWORK ARRANGEMENT

(75) Inventors: Prince Arora, Reading (GB); Ajay Vachhani, Reading (GB)

(73) Assignee: NEC CORPORATION, Tokyo (JP)

(21) Appl. No.: 12/995,646

(22) PCT Filed: Apr. 28, 2009
(86) PCT No.: PCT/JP2009/058722

§ 371 Date: Dec. 1, 2010

(30) Foreign Application Priority Data
Jun. 2, 2008 (GB) 0810004.2

(51) Int. Cl. H04W 84/02; H04W 60/00

(52) U.S. Cl. 370/338; 455/435.1

(57) ABSTRACT

A microwave radio communications device is configured to communicate with a selected one of at least first and second base stations of respective first and second cells, the first cell having a greater area of coverage than the second cell. The device is configured to retrieve data from a BSID sent from each base station and serving to discriminate between signals from the said first and second base stations indicating the relative cell coverage. Thereby the device achieves selective registration to one of the base stations responsive to the said discrimination.

### TECHNICAL FIELD

The present invention relates to a microwave radio communications device and related method of operation and network arrangement.

### BACKGROUND ART

A microwave radio communication device such as, for example, WiMAX Customer Premises Equipment (CPE), WiMAX Subscriber Stations (SS) and WiMAX Mobile Stations (MS) are well-known elements of a WiMAX communication system. Such devices are arranged to communicate with a WiMAX base station and offer wireless microwave connectivity over distances far in excess of that exhibited by WiFi systems.

Although WiMAX systems employ WiMAX base stations associated with a corresponding WiMAX cells that have a relatively large geographical coverage, requirements for, sometimes complete, overlap between larger primary WiMAX cells and smaller, generally more localised secondary WiMAX cells often arise. That is, more localised Femto cells can be required within the coverage area of Macro cell and can be employed to assist with reduction in the load on the Macro cell and its associated Macro base station.

### SUMMARY OF INVENTION

### Technical Problem

However, known arrangements are disadvantageously limited in the manner in which, for example, a user device such as a WiMAX CPE or WiMAX MS can discriminate between signals received from a Macro cell base station and those from a Femto cell base station so as to identify which base stations are available for registration purposes.

An exemplary object of the present invention is to provide for a microwave radio communications device and related method of operation and network arrangement having advantages over known such devices, methods and arrangements.

### Solution to Problem

According to one aspect of the present invention there is provided a microwave radio communications device for communication with a selected one of at least first and second base stations of respective first and second cells, the first cell having a greater area of coverage than the second cell. The device is configured to retrieve data from a BSID sent from each base station and serving to discriminate between signals from the said first and second base stations indicating the relative cell coverage. Thereby the device achieves selective registration to one of the base stations responsive to the said discrimination.

According to another aspect of the invention there is provided a microwave radio communication base station device of a first cell for communication with a microwave radio communication device, the base station device being arranged for transmitting signalling including a BSID serving to differentiate the said base station device from another base station device serving a second cell of lesser area of coverage and for facilitating base station device selection at the microwave radio communication device dependent upon the relative cell coverages.

According to yet another aspect of the invention, there is provided a method of controlling selected connection in a microwave radio communications device with one of at least a first and second base station of respective first and second cells, the second cell having a lesser area of coverage than the first cell and including the step of retrieving data at the said device from base station originating BSIDs and for discriminating between signals from the said first and second base stations indicating the relative cell coverage for selected connection to one of the base stations and responsive to the discrimination step.

According to a further aspect of the present invention a base station identification microwave signal comprising an operator identification portion and a base station identification portion, said base station identification portion including data serving to identify the base station from which the signal originates so as to allow discrimination between the said base stations and thereby respective cells at a microwave radio communication device arranged to receive the signal and on the basis of the respective areas of coverage of the cells.

### ADVANTAGEOUS EFFECTS OF INVENTION

As will be appreciated, adaption of the BSID so as to provide an indicator for discriminating between different cells can prove particularly advantageous when serving to provide for prioritised registration to at least one of the cells. Such prioritised registration can advantageously be employed within a Macro/Femto cell environment.

### BRIEF DESCRIPTION OF DRAWINGS

FIG. 1 is a schematic plan view of a WiMAX system configuration arranged for employing the present invention.

FIG. 2 is a schematic block diagram of a WiMAX user device in the form of a mobile handset and according to an embodiment of the present invention.

FIG. 3 is a schematic block diagram of a WiMAX base station according to another embodiment of the present invention.

FIG. 4 is an illustration of broadcast signalling from a base station and having a structure embodying a further aspect of the present invention.

FIG. 5 is a flow diagram according to an exemplary embodiment of the present invention.

FIG. 6 is a flow diagram according to an exemplary embodiment of the present invention.

### DESCRIPTION OF EMBODIMENTS

### First Exemplary Embodiment

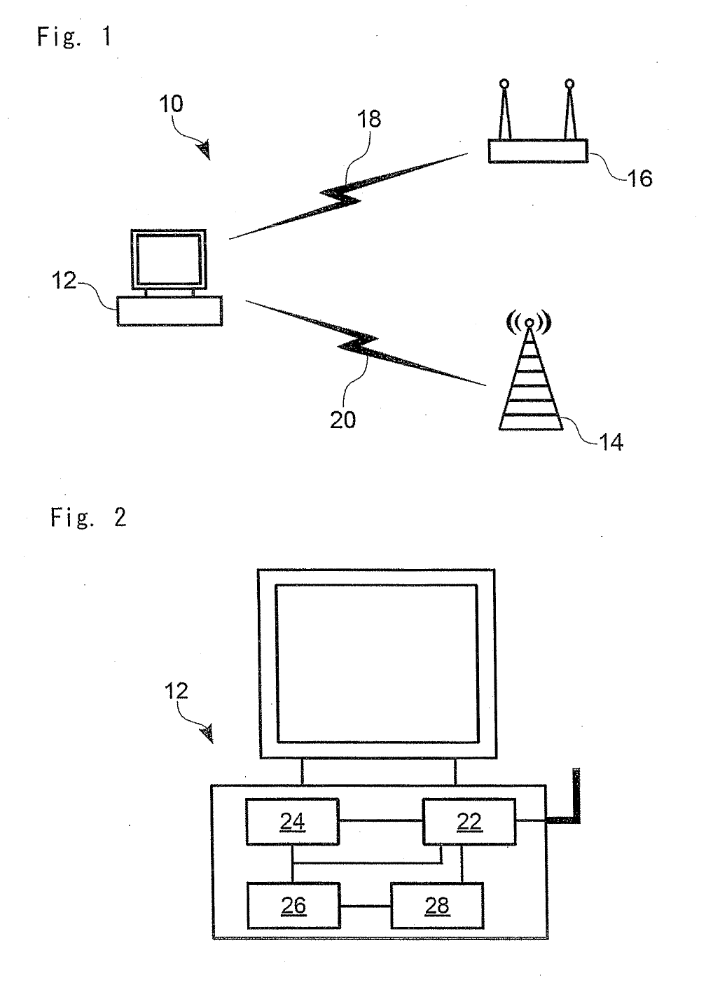

Turning first to FIG. 1 there is illustrated a plan view of a wireless communication system 10 within which a WiMAX user device 12 in the form of a WiMAX CPE is arranged for registration with either a WiMAX base station 14 of a WiMAX Macro cell, or a WiMAX Femto base station 16 of a WiMAX Femto cell. As will be appreciated, the Femto cell offers a more localised geographical coverage and can be advantageously arranged to reduce the load on the WiMAX Macro base station 14.

As usual Downlink (DL)-MAP signalling 18, 20 occurs respectively between the WiMAX user device 12 and the base stations 16, 14 and is discussed in further detail below.

Turning now to FIG. 2, there is illustrated, in block schematic form, further detail of a WiMAX user device 12 of FIG. 1.

The user device 12 includes transceiver functionality 22 along with standard processing functionality 24 and memory functionality 26. As will be appreciated below, the device also includes functionality 28 for recovering data from the base stations 14, 16 serving to discriminate between the said signalling therefrom and to thereby identify the related WiMAX cells available to the handset.

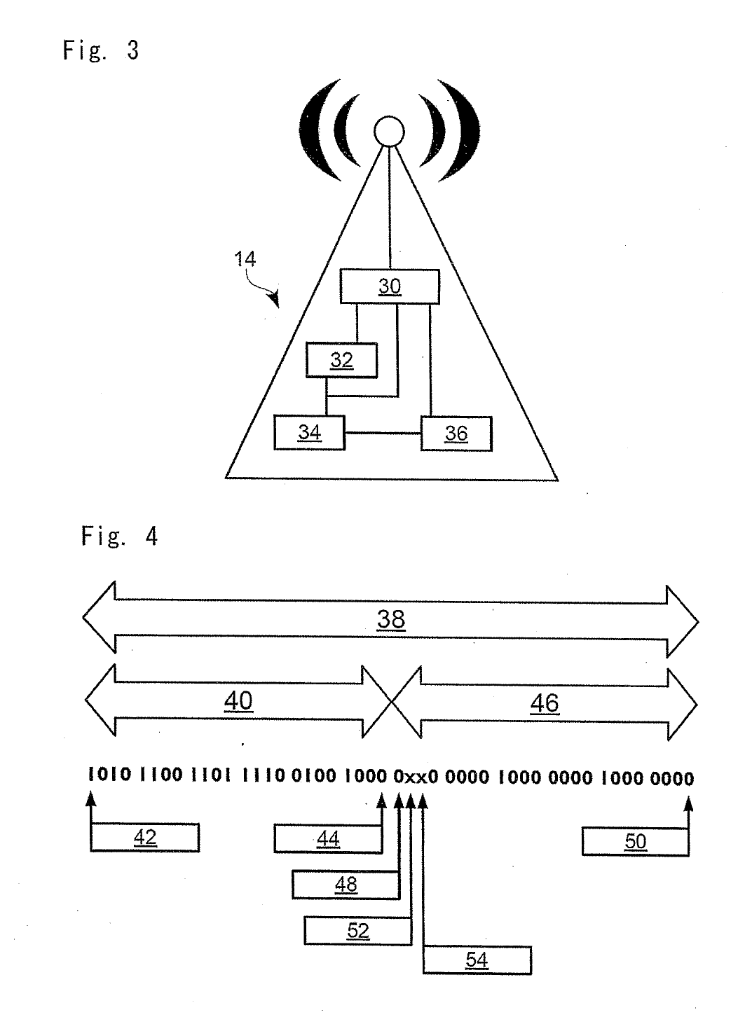

FIG. 3 represents a schematic block diagram of base station 14 of FIG. 1, but could likewise represent schematically the Femto cell base station 16, and is provided with standard transceiver functionality 30, processing functionality 32 and memory functionality 34. In addition, identifier functionality 36 is included for incorporating a base station identifier within the signalling to be transmitted from the WiMAX base station 14 to the WiMAX user device 12.

The further particulars of the features functionality 28, 36 of the devices 12 and 14 of FIGS. 2 and 3 respectively will be readily appreciated from the description below.

As noted, the identifier functionality 36 of the base station 14 is arranged to include a base station identifier within signalling transmitted to the WiMAX user device 12 which, upon receipt, and by way of its retrieval functionality 28 can readily identify, and discriminate between, signalling arising from each of the base stations 14, 16 and in a particularly efficient manner.

As will be appreciated, when a user first switches on the WiMAX user device 12, the device scans the DL channel within the operational frequency band in an attempt to detect the preamble of a DL sub-frame as transmitted from a base station. Once the preamble has been detected, the user device 12 will then attempt to acquire the DL-MAP within the DL signalling since the DL-MAP commonly contains the Base Station Identification (BSID) which comprises a combination of base station identifier and operator identifier providing the identity of the actual network operator.

A particular advantageous features of the first exemplary embodiment and which leads to advantageously efficient operation thereof, is that the BSID is employed to allow the user device to readily distinguish between signals from the different WiMAX cells which, in this particular illustrative embodiment, comprises a Macro cell and a Femto cell.

One embodiment of the manner in which the BSID can be manipulated to provide for such advantageous identification is illustrated with reference to FIG. 4.

As will be appreciated, the BSID 38 comprises a unique global identifier generally forty-eight bits long wherein the upper twenty-four bits 40 contain a unique identifier of the Network Access Provider Identifier (NAP ID) having a first, most significant, bit 42 and a twenty-fourth most significant bit 44 as illustrated in FIG. 4.

The main twenty-four bits of the BSID 38 form the BS identity in which a first bit 48 provides for a Network Service Provider (NSP) identifier flag. In accordance with the particular illustrated embodiments of the present invention, the initial bit 48 of the BS identifier 46 is then followed by the Femto cell identifier bit 52 and a Femto cell operation mode bit 54. As will be appreciated, the BS identifier 46 has a further twenty-one bits culminating in the least significant bit 50 as illustrated.

As noted above, the BSID 38 is broadcast from the WiMAX network base station as part of the DL-MAP message and, as will now be appreciated with reference to FIG. 4, this message is adapted so as to provide a readily identifiable indication as to whether the BSID 38 received at the user device 12 is associated with the Macro cell or Femto cell base stations 14, 16 of in FIG. 1.

As one example, the applied rules are that if the Femto cell identifier bit 52 is “0” then the BSID 38 is taken to be that of a Macro cell, whereas if the cell identifier bit 52 is “1” the BSID 38 is taken to be that of a Femto cell.

Various modes of operation might also be available, such as with the Femto cell a closed mode or open mode. The closed mode provides restricted access to the cell, wherein the open mode provides unrestricted access to the cell. The relevant mode of operation can be illustrated by way of the operation mode bit 54 as also illustrated with reference to FIG. 4.

Again, the particular ruling adopted can be that of a “0” for the operation mode bit 54 to represent open mode, and a “1” for the operation mode bit 54 to represents closed mode.

Of course, if the cell identifier bit has already identified the BSID as emanating from a Macro cell, the operational mode bit 54 can be reserved and set to “0”.

Returning to FIG. 1 therefore, it will be appreciated that the DL-MAP signalling delivered from the WiMAX Macro base station 14 has a BSID within which the cell identifier bit is set to “0” and the operation mode bit is reserved but with a default value “0”. The DL-MAP arising from the WiMAX Femto cell base station 16 includes a BSID with the cell identifier bit set to “1”, and the operation mode bit 54 set to either “0” or “1” depending upon the particular open/closed mode of operation of the WiMAX Femto cell base station 16.

Thus, the exemplary embodiment of the invention as illustrated with reference to FIGS. 1 and 4, allows the operation mode of the Femto cell to be readily derived from the BSID since it is included with the DL-MAP messaging delivered from the base station 16.

The exemplary embodiment of the invention therefore allows for ready and efficient identification of the presence of a Femto cell within a particular locality, and to thereby readily distinguish that cell from a Macro cell also available such that the user can readily select to camp-on the Femto cell if available.

Such ready identification of the Femto cell therefore serves to allow for ease and accuracy of selection of that Femto cell so as to, amongst other things, reduce the load in the Macro cell. First priority can therefore be readily given to the Femto cell even when the user device is first switched on, or during handover/cell reselection procedures.

Also, the provision of ready identification of the mode of operation of the particular cell can also serve to reduce power requirements and power wastage by preventing attempted registration with, a Femto cell that is closed to a particular user device. Ready identification of whether the cell is operating in open, or closed, mode therefore further enhances the advantageous and efficient operation arising from the various embodiments of the present invention.

As an example therefore, and with reference to the schematic diagram of FIG. 2, the memory functionality 26 of the user device 12 can be arranged to store a list of cells with which the particular handset can achieve registration and, in particular those cells that might be closed to access by other devices.

In particular, once the user device is registered with a WiMAX network by way of a Femto cell operating in closed mode, the device is arranged to store the BSID of that particular Femto cell within its memory functionality so as to create a “stored closed mode Femto cell list” which can be employed subsequently in particular during reselection/handover procedures since preferential registration procedures can be given to any WiMAX base station whose identification matches that contained within the aforementioned stored cell list. This can advantageously reduce unnecessary scanning of other frequencies corresponding to BSIDs that might arise from neighbouring cells.

Of course, and as will be appreciated below, the stored listing is maintained dynamically such that it can readily be supplemented by further BSIDs as subsequent successful registrations occur. Alternatively the stored listing can be revised by deletion of a BSID from the stored list subsequent to failure to achieve registration with the related base station.

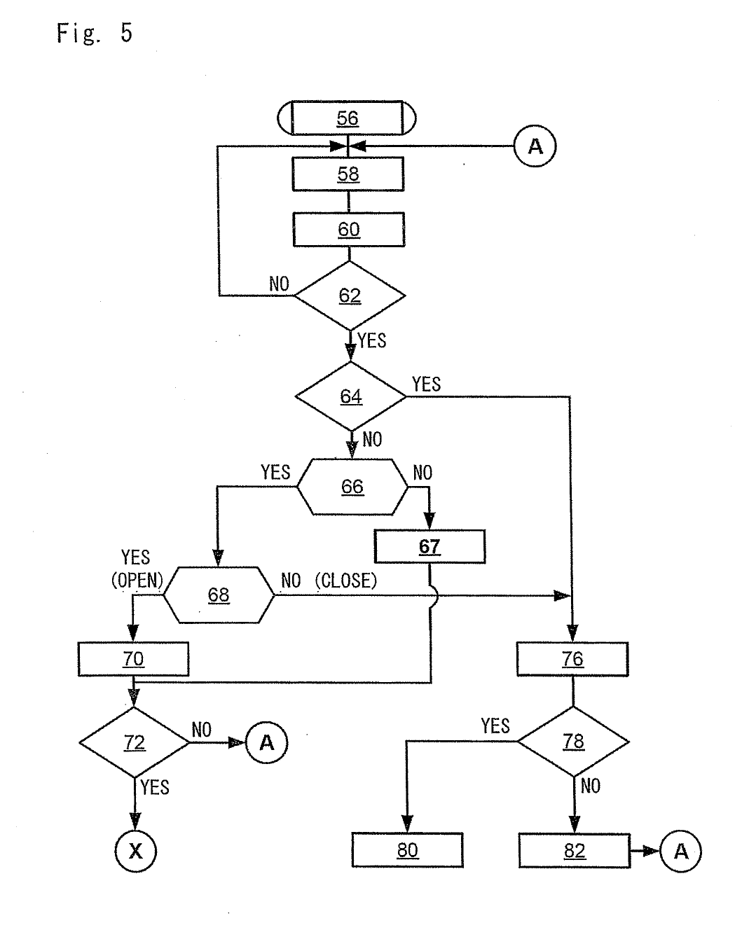

Turning now to FIG. 5, there is provided a flow diagram illustrating operation in relation to potential Femto cell detection during a power-on sequence for the user device 12 such as that illustrated in FIG. 1.

After power-on at step 56, the WiMAX user device 12 scans the downlink frequency in the operational band in an attempt to achieve camp-on with the first suitable cell identified (step 58). After the reading DL-MAP and its associated BSID at step 60, it is determined at step 62 whether the BSID is that of a permitted operator. Assuming that this is to be the case, the procedure continues to step 64 where it is determined whether or not the BSID exists within the “closed in the Femto cell list” stored within the user device 12. If, at step 64, it is determined that the BSID does not exist in that stored list, a determination is then made as step 64 as to whether the BSID is that of a Femto cell. If a Femto cell is identified, the procedure continues to step 68 where a determination of a particular operational mode of the cell is made. If, at step 68, the operational mode is identified as “open” then a camp-on procedure with the Femto cell commences at step 70 along with a subsequent determination as to whether successful registration is achieved at step 72. If successful registration is achieved then post-registration signalling procedures continue between the user device and the relevant post station device as indicated at “X”.

If, at step 66, it is determined that the BSID is not that of a Femto cell, then by default the cell is identified as a Macro cell at step 67 the user device 12 attempts to camp-on with that Macro cell with the aforesaid subsequent indication at step 72 as to whether registration has proved successful. Should, at step 64, it be identified that the BSID exists within the “closed mode Femto cell list”, or should it be determined at step 68 that the operation mode of the cell is “closed” then the process continues to step 72 where a camp-on procedure with the Femto cell commences. If such camp-on with the Femto cell proves successful, such that registration is determined to be successful at step 78, the BSID can be added to the “closed mode Femto cell list” at step 80 if it is not already present.

Should, at step 78 it be determined that registration was not successful, then the particular BSID, if already present in the “closed mode Femto cell list” can be deleted therefrom.

Of course, if at either step 72 or 78 the Femto registration was not successful, then the procedure returns to the original frequency scan stage as indicated by “A”.

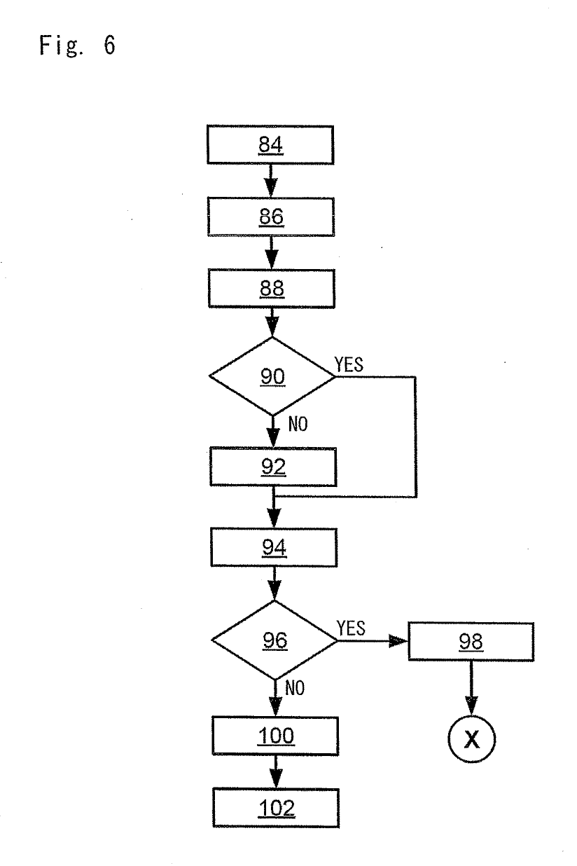

Turning now to FIG. 6, there is illustrated a flow diagram related to a cell reselection or handover procedure.

As shown in FIG. 6, initially the WiMAx user device 12 is camped on at 84 with the Macro cell 14. When cell re-selection or handover triggers 86, then a probable list of BSIDs of neighbour cells is provided 88 to the user device 12. According to this aspect of the present invention, if it is determined that neighbour cell's BSID exists 90 in the “closed mode Femto cell list”, then the device 12 will prefer to camp-on with that Femto cell. Otherwise the device 12 will give preference 92 to others Femto cell BSID. Subsequent to camp-on with the Femto cell 94 the WiMAX user device 12 can store 98 the BSID (if it does not already exist) in the “closed mode Femto cell list”. If however there as no successful registration such that WiMAX user device 12 is not able to camp-on with the Femto cell, then the WiMAX user device 12 will delete 100 the entry of the BSID from the “closed mode Femto cell list”. Assuming that it exists. Subsequently, the WiMAX user device 12 will at 102 try to camp-on with the other cells found in the Neighbour Cell List, but first priority can be given to Femto cells.

As will be appreciated, the first embodiment of the invention can provide for a particularly efficient mechanism for identification of a Femto cell by means of a one-bit identifier within the structure of the BSID. Also a one-bit identifier within the same BSID can be employed so as to, for example, indicate the operation mode of the Femto cell.

The present invention finds particular use within the WiMAX environment and particularly in relation to for WiMAX CPE, WiMAX MS and any WiMAX user and network device. Priority of camp-on with Femto cells can therefore be readily achieved so as to efficiently realise an advantageous reduction in load on a Macro cell.

### Other Exemplary Embodiments

In other exemplary embodiment, a microwave radio communications device includes storage means for retaining a list of local cells with which the device can achieve registration.

The device can then include comparison means for comparing the content of the said list with a cell identified by way of the said discrimination.

For dynamic control of the list, the device can include means for entering a cell identifier within the said memory responsive to successful registration therewith.

Likewise, the device can include means for removal of the cell identity from the said memory if registration proves unsuccessful.

In particular, the device can be arranged to receive data from a base station identification portion of the BSID.

Preferably a single bit within the BSID can be employed to indicate the identity of the cell.

Yet further, the device can be arranged to retrieve data from the BSID including an operational mode indicator. Again, the operational mode indicator can be provided within the base station identifier part of the BSID. Also, the said data includes a single bit of the base station part of the BSID.

In still other exemplary embodiment, a method includes the step of allowing for the storage of a list of local cells with which the device can achieve registration. In particular, a list of cells has closed availability.

The method can then also include a step of comparing the content of the said list with a cell identified by way of the discriminating step.

Preferably, the method can include the step of entering a cell identifier within the said memory responsive to successful registration therewith, and/or the removal of the cell identity from the said memory if registration proves unsuccessful.

Again, the method advantageously employs a base station identification portion of the BSID for transport of the said data and, in particular, a single bit within the BSID can be employed to indicate the identity of the cell.

The BSID can also be employed for the provision of an operational mode indicator which can be provided within the base station identifier part of the BSID, and preferably as a single bit thereof.

It should be appreciated that the functionality of the various devices noted above can be provided as part of a hardware or software solution depending upon particular requirements.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### INCORPORATION BY REFERENCE

This application is based upon and claims the benefit of priority from UK patent application No. 0810004.2, filed on Jun. 2, 2008, the disclosure of which is incorporated herein in its entirety by reference.

### REFERENCE SIGNS LIST

10 Wireless communication system
12 WiMAX user device
14 WiMAX Macro base station
16 WiMAX Femto base station
18 DL-MAP signalling
20 DL-MAP signalling
22 Transceiver functionality
24 Processing functionality
26 Memory functionality
28 Functionality for recovering data from the base stations
30 Transceiver functionality
32 Processing functionality
34 Memory functionality
36 Identifier functionality
38 BSID
40 NAP ID
42 Most significant bit
44 Twenty-fourth most significant bit
46 BS identifier
48 NSP identifier flag
50 Least significant bit
52 Femto cell identifier bit
54 Femto cell operation mode bit

1. A microwave radio communications device for communication with a selected one of at least first and second base stations of respective first and second cells, the first cell having a greater area of coverage than the second cell, the device comprising a unit adapted to retrieve data from a BSID sent from each base station and serving to discriminate between signals from the said first and second base stations indicating the relative cell coverage and thereby achieve selective registration to one of the base stations responsive to the said discrimination.

2. A device as claimed in claim 1, wherein the first and second cells comprise at least a Macro cell and a localised cell and wherein the discrimination allows for priority registration to the localised cell.

3. A device as claimed in claim 2, wherein the localised cell comprises a Femto cell.

4. A device as claimed in claim 1, further comprising a storage unit adapted to retain a list of said second cells with which the device can achieve registration.

5. A device as claimed in claim 4, wherein the list comprises cells having closed availability.

6. A device as claimed in claim 4, further comprising a unit adapted to compare the content of the said list with a cell identified by way of the said discrimination.

7. A device as claimed in claim 4, further comprising a unit adapted to enter a cell identifier within the said list responsive to successful registration therewith.

8. A device as claimed in claim 4, further comprising a unit adapted to remove an entry of a cell from the said list if registration therewith proves unsuccessful.

9. A device as claimed in claim 1, and arranged to receive the said data from a base station identification portion of the BSID.

10. A device as claimed in claim 9, wherein the data comprises a single bit, within the BSID, that is employed to indicate an identity of a cell from which the BSID originates.

11. A device as claimed in claim 1, and arranged to retrieve data from the BSID comprising an operational mode indicator.

12. A device as claimed in claim 11, wherein the operational mode indicator is provided within a base station identification portion of the BSID.

13. A device as claimed in claim 12, wherein the operational mode indicator comprises a single bit of the base station part of the BSID.

14. A microwave radio communication base station device of a first cell for communication with a microwave radio communication device, the base station device being arranged for transmitting signalling comprising a BSID serving to differentiate the said base station device from another base station device serving a second cell of lesser area of coverage and for facilitating base station device selection at the microwave radio communication device dependent upon the relative cell coverages.

15. A device as claimed in claim 14, wherein the first and second cells comprise at least a Macro cell and a localised cell and wherein the discrimination allows for priority registration to the localised cell.

16. A device as claimed in claim 15, wherein the localised cell comprises a Femto cell.

17. A device as claimed in claim 14, and arranged to include data indicating an identity of a cell from which the BSID originates within a base station identification portion of the BSID.

18. A device as claimed in claim 17, wherein a single bit within the BSID is employed to indicate the identity of the cell.

19. A device as claimed in claim 14, and arranged to include data within the BSID comprising an operational mode indicator.

20. A device as claimed in claim 19, wherein the operational mode indicator is provided within a base station identification portion of the BSID.

21. A device as claimed in claim 20, wherein the operational mode indicator comprises a single bit of the base station identification portion of the BSID.

22. A microwave radio communications system comprising a communication device as claimed in claim 1, and a base station device as claimed in claim 14.

23. A method of controlling selected connection in a microwave radio communications device with one of at least a first and second base station of respective first and second cells, the second cell having a lesser area of coverage than the first cell and comprising the step of retrieving data at the said device from base station originating BSIDs and for discriminating between signals from the said first and second base stations indicating the relative cell coverage for selected connection to one of the base stations and responsive to the discrimination step.

24. A method as claimed in claim 23, wherein the first and second cells comprise at least a Macro cell and a localised cell and wherein the discrimination allows for priority registration to the localised cell.

25. A method as claimed in claim 24, wherein the localised cell comprises a Femto cell.

26. A method as claimed in claim 23, further comprising the step of retaining, in a memory, a list of local cells with which the device can achieve registration.

27. A method as claimed in claim 26, wherein the list comprises cells having closed availability.

28. A method as claimed in claim 26, further comprising the step of comparing the content of the said list with a cell identified by way of the said discrimination.

29. A method as claimed in claim 26, further comprising the step of entering a cell identifier within the list responsive to successful registration therewith.

30. A method as claimed in claim 26, further comprising the step of removing an entry of a cell from the list if registration therewith is unsuccessful.

31. A base station identification microwave signal comprising an operator identification portion and a base station identification portion, said base station identification portion comprising data serving to identify a base station from which the signal originates so as to allow discrimination between base stations and thereby respective cells at a microwave radio communication device arranged to receive the signal and on the basis of the respective areas of coverage of the cells.

32. A signal as claimed in claim 31, wherein the respective cells comprise at least a Macro cell and a localised cell and wherein the discrimination allows for priority registration to the localised cell.

33. A signal as claimed in claim 32, wherein the localised cell comprises a Femto cell.

34. A signal as claimed in claim 31, wherein the data comprises a single bit that is employed to indicate an identity of a cell from which the signal originates.

35. A signal as claimed in claim 31, further comprising an operational mode indicator.

36. A signal as claimed in claim 35, wherein the operational mode indicator is provided within the base station identification portion.

37. A signal as claimed in claim 36, wherein the operational mode indicator comprises a single bit of the base station identification portion.

38. Computer program product comprising computer program instructions which, when loaded within a processing device, are arranged to provide a method of operation as defined in claim 23.

39. A record media comprising a computer program product as claimed in claim 38.
